(19) United States
(12) Patent Application Publication
(10) Pub. No.: US 2024/0158892 A1
(43) Pub. Date: May 16, 2024

(54) Al-Mn-Zr BASED ALLOYS FOR HIGH TEMPERATURE APPLICATIONS

(71) Applicant: NanoAL LLC, Ashland, MA (US)

(72) Inventors: James KIDD, Ashland, MA (US); Nhon Q. VO, Winchester, MA (US); Joseph R. CROTEAU, Boston, MA (US); Joshua P. DORN, Cambridge, MA (US)

(73) Assignee: NanoAL LLC, Ashland, MA (US)

(21) Appl. No.: 18/238,270

(22) Filed: Aug. 25, 2023

Related U.S. Application Data
(63) Continuation of application No. PCT/US2022/018012, filed on Feb. 25, 2022.
(60) Provisional application No. 63/154,165, filed on Feb. 26, 2021.

(51) Int. Cl. C22C 21/00; B22F 10/28; B33Y 10/00; B33Y 70/00; B33Y 80/00; C22C 1/02; C22C 1/03; C22F 1/04

(52) U.S. Cl. CPC C22C 21/00; B22F 10/28; C22C 1/026; C22C 1/03; C22F 1/04; B22F 2301/052; B22F 2303/01; B22F 2998/10; B33Y 10/00; B33Y 70/00; B33Y 80/00

(57) ABSTRACT

This application relates to Al—Mn—Zr based alloys, which when processed by (i) a conventional manufacturing technique (e.g. casting), (ii) an additive manufacturing technique utilizing a melting process, or (iii) a powder metallurgy process can provide a fabricated component with significantly improved strength, creep resistance and/or thermal stability at elevated temperatures, and printability in additive manufacturing and weldability in traditional manufacturing compared to conventional aluminum alloy.

### CROSS-REFERENCE TO RELATED APPLICATIONS

This application claims the benefit of and priority to U.S. Provisional Application No. 63/154,165, filed on Feb. 26, 2021, which is hereby incorporated by reference in its entirety.

### TECHNICAL FIELD

This application relates to Al—Mn—Zr aluminum alloys, which, when processed by (i) a conventional manufacturing technique (e.g. casting), (ii) an additive manufacturing technique utilizing a melting process, or (iii) a powder metallurgy process can fabricate a component with significantly improved strength, creep resistance and thermal stability at elevated temperatures, and printability in additive manufacturing and weldability in traditional manufacturing compared to conventional aluminum alloys.

### BACKGROUND

There is a strong demand for low-density components in transportation applications such as in or near engine components. These applications necessitate the design and fabrication of light-weight aluminum alloys for high-temperature use. Most conventional aluminum alloys cannot operate beyond 220° C. due to the rapid coarsening and/or dissolving of the strengthening precipitate phases such as in 2000-series aluminum alloys (Al—Cu-based). AA2618 and AA2219 (Al—Cu-based alloys) are amongst the best aluminum alloys that can operate at high temperatures, but their use is also limited to below 220° C.

Recent development of aluminum alloys containing rare-earth elements, such as scandium (Sc) and cerium (Ce), can extend the operating temperature to above 220° C. However, these new alloys have multiple drawbacks. Sc is a very expensive element (about 10 times as expensive as silver) which severely limits its applications. Ce is less expensive than Sc, but it is a limited resource. A large amount of Ce (about 10% by weight) is alloyed with aluminum in practice, which results in low ductility at room temperature and limits its applications. Another approach for fabricating a high-temperature aluminum alloy is by creating a metal matrix composite, in which ceramic phases are incorporated into an aluminum alloy matrix. This approach requires a complicated manufacturing process, causing a fabricated metal-ceramic composite component to be expensive. Metal-ceramic composites also suffer from low ductility.

Recent development of Al—Mn—Si—Fe—Zr-inoculant alloys that contain two populations of thermally stable precipitates—(i) primary Al—Mn—Si—Fe so-called alpha phases with nanometer to micrometer size and (ii) high number density of L1₂-structured Al₃Zr nanoprecipitates—can achieve a reasonable strength at room temperature, but a very good strength at elevated temperatures up to 400° C. However, these alloys only contain Mn, Fe, Si, and Zr up to 1.5 wt. %, 0.7 wt. %, 0.6 wt. %, and 0.5 wt. % respectively, which does not take advantage of performance improvement of alloys that contain higher total alloying contents. This technology is disclosed in U.S. Patent Publication No. 2019/0390312, which is incorporated herein by reference in its entirety.

In the modern aluminum manufacturing industry, processes can be categorized in either (i) traditional manufacturing or (ii) additive manufacturing. A common method within traditional manufacturing is aluminum casting in which a molten aluminum alloy is poured into a net-shape or near-net-shape mold and the cast parts are then machined into the final components. Other common methods within traditional manufacturing are to produce wrought products by means of extrusion, rolling, forging and wire drawing. These methods also start with casting a large aluminum billet which is then processed into a final shape. Powder metallurgy is another common method in traditional manufacturing, in which aluminum alloy is fabricated into powder form, which are then processed into final component by means of pressing and sintering or extrusion. In additive manufacturing, final components are built by adding many small pieces of material together, in form of powder, wire, or thin sheet, by means of joining, sintering, or melting assisted by an energy source. The source can be a laser, plasma, electric arc, or furnace. In additive manufacturing of metals, selective laser melting using metallic powder as feedstock is the most common manufacturing method to date.

Each manufacturing method has its own limitation when it comes to requirements for material feedstocks. For example, an aluminum alloy that works well in one manufacturing method does not necessary work well (if at all) in another method. Traditionally high-temperature aluminum alloys, such as AA2618 and AA2219, that work well in wrought products are shown to be unprocessable (i.e. not printable) in additive manufacturing due to a hot cracking issue. Al—Sc-based alloys, which show high-temperature performance in casting and wrought products, are proved to have low high-temperature performance in additive manufacturing due to generation of fine grain size inherited from additive manufacturing processing. Accordingly, an aluminum alloy that has high performance at elevated temperatures, which can be utilized in many different manufacturing methods (both traditional and additive) will have a significant commercial and technological value.

Additive manufacturing refers generally to a method of forming a net-shape, or near-net-shape component in an additive manner, where material is deposited one layer at a time until the desired three-dimensional shape is achieved, and as a result there is very little wasted material or scrap produced. This contrasts with conventional “subtractive manufacturing” where material is removed from a larger preform, e.g. by milling, until the final three-dimensional shape is achieved, which generally produces a lot of wasted material and scrap as a byproduct.

Additive manufacturing of metals typically utilizes spherical metal alloy powders and uses a focused energy source, such as a laser beam or an electron beam, to fuse the metal powders at specific locations to fabricate a near-net-shape component with high spatial resolution. The spherical metal powders are typically made by gas-atomization or plasma-atomization, which naturally produces spherical powders, or by plasma spherization, which transforms irregular particles into spherical powders. Typically, during these additive manufacturing techniques, the metal powders are fully melted by the energy source and solidify rapidly so that they are fused to the underlying material, which may be a preexisting substrate or a previously deposited layer of the powder material. To achieve a part with desirable relative density, i.e. >99%, multiple layers of deposited material are re-melted, typically more than once, so that there is complete fusion between each layer of deposited material. During these processes, the molten alloy solidifies rapidly, easily exceeding cooling rates of 10³° C./sec and as high as 10⁶° C./sec. This cooling rate greatly exceeds those experienced during conventional casting of molten alloys which are typically on the order of 10⁰ to 10²° C./sec. Because of the very high cooling rates inherent to additive manufacturing techniques, they are considered far-from-equilibrium, and conventional alloys, which have been optimized for equilibrium processing, cannot be easily processed by such methods.

Conventional aluminum alloys used to make cast components are based on the Al—Si eutectic system due to its good fluid properties which are favorable for liquid metal processing. For these same reasons, Al—Si-based alloys are also commonly used in additive manufacturing process which include a melting step. However, these alloys have relatively low mechanical properties at elevated temperatures and are limited to applications with operating temperature below about 150° C. For applications with operating temperature up to about 250° C., Al—Cu-based system are commonly used due to its improved thermal stability. However, the Al—Cu-based alloys are more difficult to process than Al—Si-based ones and have deleterious corrosion issues.

Thus, the discovery and development of aluminum alloys that can be utilized in additive manufacturing and have an operating temperature above 250° C. will have a significant commercial and technological value.

### SUMMARY

The embodiments described herein relate to Al—Mn—Zr alloys that exhibit, inter alia, improved mechanical strength at high temperatures, e.g., temperatures exceeding 250° C.

In some embodiments, the present disclosure provides an aluminum alloy comprising about 1 to 10% by weight manganese, about 0.3-2% by weight zirconium, and aluminum as the remainder. The alloys may further comprise up to about 5% by weight iron, up to about 5% by weight silicon, about 0.1 to about 1% by weight of one or more of titanium, hafnium, vanadium, niobium, tantalum, chromium, molybdenum, or tungsten, up to about 0.5% by weight tin, and/or up to about 1% by weight copper. The aluminum alloys of the present disclosure do not comprise any intentionally added scandium.

Powders and other forms fabricated from the disclosed aluminum alloys are useful materials in a variety of manufacturing methods described herein.

### BRIEF DESCRIPTION OF THE DRAWINGS

The drawings contained herein are an example of a microstructure of the aluminum alloys disclosed herein, the surface morphology and internal microstructure of powder of an example alloy, and aging curves of specimens of an example alloy produced by additive manufacturing, and which can be achieved by embodiments of the disclosure and are not limiting in any way.

FIG. 1: Scanning electron micrograph of a melt-spun ribbon of Al-2.4Mn-1.2Fe-1.2Si-1.0Zr wt. %. The structure displays fine primary precipitates homogenously dispersed throughout the sample.

FIG. 2: Scanning electron micrograph of surface morphology of Al-3.6Mn-1.8Fe-1.85i-0.8Zr wt. % powder produced by gas atomization. Particles are highly spherical with minor satellites and capping defects.

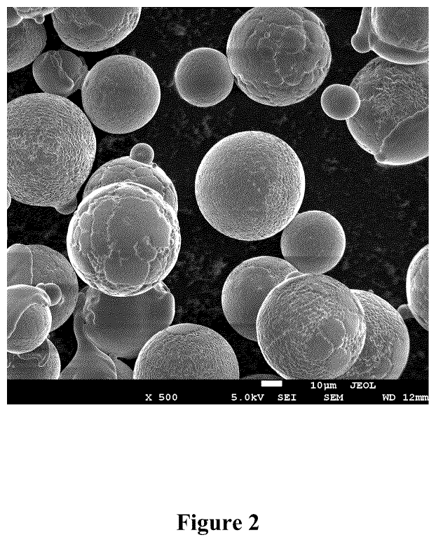

FIG. 3: Scanning electron micrograph of a cross-section of Al-3.6Mn-1.8Fe-1.85i-0.8Zr wt. % powder produced by gas atomization showing fine internal microstructure. Bright phases are AlMnFeSi eutectic intermetallic.

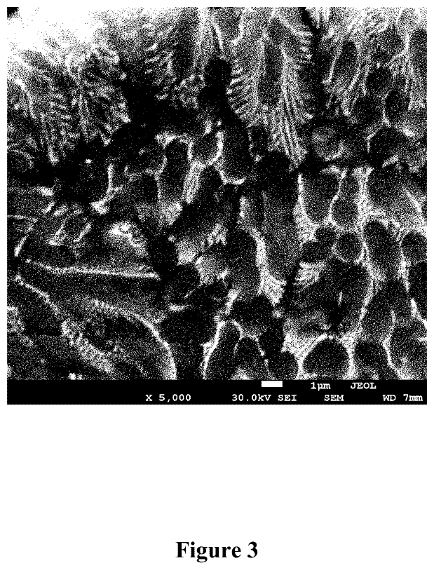

FIG. 4: Isothermal aging curves showing Vickers microhardness at temperatures from 250-400° C. for up to 72 hrs of Al-3.6Mn-1.8Fe-1.85i-0.8Zr wt. % specimens produced by selective laser melting on a 200° C. preheated build plate. Error bars represent one standard deviation taken from 10 measurements taken on the same sample.

FIG. 5: Isothermal aging curves showing electrical conductivity at temperatures from 250-400° C. for up to 72 hrs of Al-3.6Mn-1.8Fe-1.8Si-0.8Zr wt. % specimens produced by selective laser melting on a 200° C. preheated build plate.

FIG. 6: Steady-state creep rate of Al-3.6Mn-1.8Fe-1.8Si-0.8Zr wt. % specimens produced by selective laser melting at testing temperatures of 250 and 300° C., respectively.

### DETAILED DESCRIPTION

The present application discloses aluminum alloys that have improved mechanical strength at temperatures exceeding 250° C., among other advantageous properties. The aluminum alloys can be utilized in traditional manufacturing such as casting, wrought or powder metallurgy processes, or additive manufacturing such as selective laser melting and direct energy deposition.

In one embodiment, the aluminum alloy comprises about 1 to 10% by weight manganese, about 0.3 to 2% by weight zirconium, and aluminum as the remainder. The aluminum alloy does not comprise any intentionally added scandium.

In some embodiments, the aluminum alloy comprises about 1 to 10%, about 1 to 9.5%, about 1 to 9%, about 1 to 8.5%, about 1 to 8%, about 1 to 7.5%, about 1 to 7%, about 1 to 6.5%, about 1 to 6%, about 1 to 5.5%, about 1 to 5%, about 1 to 4.5%, about 1 to 4%, about 1 to 3.5%, or about 1 to 3% by weight manganese, including any range or value therebetween. In some embodiments, the aluminum alloy comprises about 2 to about 5% by weight manganese.

In some embodiments, the aluminum alloy comprises about 0.3 to 2%, about 0.3 to 1.75%, about 0.3 to 1.5%, about 0.3 to 1.25%, about 0.3 to 1%, about 0.3 to 0.75%, or about 0.3 to 0.5 by weight zirconium, including any range or value therebetween.

In some embodiments, the aluminum alloy comprises about 1 to 6% by weight manganese, about 0.3 to 1.5% by weight zirconium, and aluminum as the remainder. The aluminum alloy does not comprise any intentionally added scandium.

In some embodiments, the aluminum alloy comprises about 1 to 4% by weight manganese, about 0.5 to 1.2% by weight zirconium, and aluminum as the remainder. The aluminum alloy does not comprise any intentionally added scandium.

In some embodiments, the aluminum alloy further comprises up to about 5% by weight iron, e.g., about 0.05%, about 0.1%, 0.5%, about 1%, about 1.5%, about 2%, about 2.5%, about 3%, about 3.5%, about 4%, about 4.5%, or about 5%, including any range or value therebetween. In some embodiments, the aluminum alloy further comprises about 0.1 to 5%, about 0.1 to 4.5%, about 0.1 to 4%, about 0.1 to 3.5%, about 0.1 to 3%, about 0.1 to 2.5%, or about 0.1 to about 2% by weight iron, including any range or value therebetween. In some embodiments, the aluminum alloy further comprises about 0.2 to 5%, about 0.2 to 4.5%, about 0.2 to 4%, about 0.2 to 3.5%, about 0.2 to 3%, about 0.2 to 2.5%, or about 0.2 to about 2% by weight iron, including any range or value therebetween. In some embodiments, the aluminum alloy further comprises about 0.2 to 2% by weight iron. In some embodiments, the aluminum alloy further comprises about 0.3 to 2% by weight iron. In some embodiments, the aluminum alloy further comprises about 0.4 to 2% by weight iron. In some embodiments, the aluminum alloy further comprises about 0.5 to 2% by weight iron.

In some embodiments, the aluminum alloy further comprises up to about 5% by weight silicon, e.g., about 0.05%, about 0.1%, 0.5%, about 1%, about 1.5%, about 2%, about 2.5%, about 3%, about 3.5%, about 4%, about 4.5%, or about 5%, including any range or value therebetween. In some embodiments, the aluminum alloy further comprises about 0.1 to 5%, about 0.1 to 4.5%, about 0.1 to 4%, about 0.1 to 3.5%, about 0.1 to 3%, about 0.1 to 2.5%, or about 0.1 to about 2% by weight silicon, including any range or value therebetween. In some embodiments, the aluminum alloy further comprises about 0.2 to 5%, about 0.2 to 4.5%, about 0.2 to 4%, about 0.2 to 3.5%, about 0.2 to 3%, about 0.2 to 2.5%, or about 0.2 to about 2% by weight silicon, including any range or value therebetween. In some embodiments, the aluminum alloy further comprises about 0.2 to 2% by weight silicon. In some embodiments, the aluminum alloy further comprises about 0.3 to 2% by weight silicon. In some embodiments, the aluminum alloy further comprises about 0.4 to 2% by weight silicon. In some embodiments, the aluminum alloy further comprises about 0.5 to 2% by weight silicon.

Accordingly, in some embodiments, the present provides an aluminum alloy comprising about 1 to 10% by weight manganese, about 0.3 to 2% by weight zirconium, about 0.2 to 2% by weight Fe, and aluminum as the remainder. The aluminum alloy does not comprise any intentionally added scandium.

In some embodiments, the present provides an aluminum alloy comprising about 1 to 10% by weight manganese, about 0.3 to 2% by weight zirconium, about 0.2 to 2% by weight Fe, about 0.2 to 2% by weight silicon, and aluminum as the remainder. The aluminum alloy does not comprise any intentionally added scandium.

In some embodiments, the present provides an aluminum alloy comprising about 3.6% by weight manganese, about 0.8% by weight zirconium, about 1.8% by weight Fe, about 1.8% by weight silicon, and aluminum as the remainder. The aluminum alloy does not comprise any intentionally added scandium.

In some embodiments, an aluminum alloy of the present disclosure further comprises about 0.1 to about 1% by weight of one or more of titanium, hafnium, vanadium, niobium, tantalum, chromium, molybdenum, tungsten, e.g., about 0.1%, about 0.2%, about 0.3%, about 0.4%, about 0.5%, about 0.6%, about 0.7%, about 0.8%, about 0.9%, or about 1%, including all ranges and values therebetween.

In some embodiments, an aluminum alloy of the present disclosure further comprises up to about 0.5% by weight tin, e.g., about 0.05%, about 0.1%, about 0.15%, about 0.2%, about 0.25%, about 0.3%, about 0.35%, about 0.4%, about 0.45%, or about 0.5%, including all ranges and values therebetween. In some embodiments, the aluminum alloy further comprises about 0.05 to about 0.5% by weight of tin, e.g., about 0.05%, about 0.1%, about 0.15%, about 0.2%, about 0.25%, about 0.3%, about 0.35%, about 0.4%, about 0.45%, or about 0.5%, including all ranges and values therebetween.

In some embodiments, an aluminum alloy of the present disclosure further comprises up to about 1% by weight copper, e.g., about 0.1%, about 0.2%, about 0.3%, about 0.4%, about 0.5%, about 0.6%, about 0.7%, about 0.8%, about 0.9%, or about 1%, including all ranges and values therebetween. In some embodiments, the aluminum alloy further comprises about 0.05 to about 1% by weight of copper, e.g., about 0.05%, about 0.1%, about 0.2%, about 0.3%, about 0.4%, about 0.5%, about 0.6%, about 0.7%, about 0.8%, about 0.9%, or about 1%, including all ranges and values therebetween. Without being bound by any particular theory, the copper present in the disclosed aluminum alloy can be used to inoculate alpha phase precipitation.

In some embodiments, the aluminum alloy comprises about 1 to 10% by weight manganese, about 0.3 to 2% by weight zirconium, about 0 to 5% by weight iron, about 0 to 5% by weight silicon, and aluminum as the remainder. The aluminum alloy does not comprise any intentionally added scandium.

In some embodiments, the aluminum alloy comprises about 1.2 to 6% by weight manganese, about 0.3 to 1% by weight zirconium, about 0 to 1.8% by weight iron, about 0 to 1.8% by weight silicon, and aluminum as the remainder. The aluminum alloy does not comprise any intentionally added scandium.

In some embodiments, the aluminum alloy comprises about 1 to 5% by weight manganese, about 0.3 to 1.5% by weight zirconium, about 0.5 to 3% by weight iron, about 0.5 to 3% by weight silicon, and aluminum as the remainder. The aluminum alloy does not comprise any intentionally added scandium.

In one embodiment, the aluminum alloy comprises about 1 to 10% by weight manganese, about 0.3 to 2% by weight zirconium, about 0 to 5% by weight iron, about 0 to 5% by weight silicon, about 0.1 to about 1% by weight of one or more of titanium, hafnium, vanadium, niobium, tantalum, chromium, molybdenum, tungsten, and aluminum as the remainder. The aluminum alloy does not comprise any intentionally added scandium.

In one embodiment, the aluminum alloy comprises about 1 to 7% by weight manganese, about 0.3 to 1.5% by weight zirconium, about 0.5 to 3% by weight iron, about 0.5 to 3% by weight silicon, about 0.1 to about 1% by weight of one of or more of titanium, hafnium, vanadium, niobium, tantalum, chromium, molybdenum, tungsten, and aluminum as the remainder. The aluminum alloy does not comprise any intentionally added scandium.

In one embodiment, the aluminum alloy comprises about 1 to 10% by weight manganese, about 0.3 to 2% by weight zirconium, about 0 to 5% by weight iron, about 0 to 5% by weight silicon, about 0.1 to about 1% by weight of one or more of titanium, hafnium, vanadium, niobium, tantalum, chromium, molybdenum, tungsten, about 0 to 0.5% by weight tin and/or about 0 to 1% by weight copper for inoculating alpha phase precipitation, and aluminum as the remainder. The aluminum alloy does not comprise any intentionally added scandium.

In one embodiment, the aluminum alloy comprises about 1 to 7% by weight manganese, about 0.3 to 1.5% by weight zirconium, about 0.5 to 3% by weight iron, about 0.5 to 3% by weight silicon, about 0.1 to about 1% by weight of one or more of titanium, hafnium, vanadium, niobium, tantalum, chromium, molybdenum, tungsten, about 0.1 to 0.5% by weight tin and/or about 0.1 to 1% by weight copper for inoculating alpha phase precipitation, and aluminum as the remainder. The aluminum alloy does not comprise any intentionally added scandium.

In some embodiments, the amount of unintentionally added scandium in the disclosed alloys is less than about 0.5%, less than about 0.4%, less than about 0.3%, less than about 0.2%, less than about 0.1%, less than about 0.09%, less than about 0.08%, less than about 0.07%, less than about 0.06%, less than about 0.05%, less than about 0.04%, less than about 0.03%, or less than about 0.02% by weight scandium, including any range of value therebetween.

In some embodiments, the aluminum alloys comprise about 0 to about 0.5% by weight of unavoidable impurities, e.g., about 0.01%, about 0.05%, about 0.1%, about 0.15%, about 0.2%, about 0.25%, about 0.3%, about 0.35%, about 0.4%, about 0.45%, or about 0.5% by weight of unavoidable impurities. In some embodiments, the aluminum alloys comprise less than about 0.5%, less than about 0.4%, less than about 0.3%, less than about 0.2%, or less than about 0.1% by weight of unavoidable impurities. As would be understood by one of skill in the art, unavoidable impurities present in the disclosed alloys have no measurable impact on the properties of the alloy, for example its tensile strength, Vickers hardness, maximum hardness, or any other property described herein.

In some embodiments, the alloys of the present disclosure comprise greater than about 90% aluminum by weight, greater than about 91% aluminum by weight, greater than about 92% aluminum by weight, greater than about 93% aluminum by weight, greater than about 94% aluminum by weight, greater than about 95% aluminum by weight, greater than about 96% aluminum by weight, greater than about 97% aluminum by weight, or greater than about 98% aluminum by weight. In some embodiments, the alloys of the present disclosure about 90% aluminum by weight, about 91% aluminum by weight, about 92% aluminum by weight, about 93% aluminum by weight, about 94% aluminum by weight, about 95% aluminum by weight, about 96% aluminum by weight, about 97% aluminum by weight, or about 98% aluminum by weight.

The disclosed aluminum alloys are especially advantageous for powder-based additive manufacturing techniques including but not limited to, laser powder bed fusion, directed energy deposition, laser engineered net shaping, and laser cladding, and wire-based additive manufacturing techniques, such as wire-arc additive manufacturing. The alloys have been specifically designed so that they are easily processed by such methods where rapid melting and solidification are inherent to the processing.

The disclosed alloys are, for example, advantageous for improving the high-temperature performance of aluminum components that experience elevated temperature conditions in aerospace and automotive applications, in sporting goods including racing and leisure equipment, and in consumer goods.

The embodiments described herein relate to a family of Al—Mn-based aluminum alloys, comprising manganese, iron, silicon, zirconium and unavoidable impurities. The aluminum alloys have been developed to achieve a thermally stable (up to about 550° C.) microstructure, resulting in excellent mechanical properties at temperatures exceeding 250° C.

In one embodiment, the aluminum alloy of the present disclosure comprises an aluminum matrix with a simultaneous dispersion of precipitates bearing Mn, Fe, and/or Si, and Al₃Zr primary precipitates having an average diameter ranging from about 0.05 to about 5 μm. In another embodiment, the aluminum alloy comprises Al₃Zr nano-precipitates with L1₂ crystal structure having an average diameter ranging from about 3 to about 50 nm.

The aluminum alloys, when fabricated into a component, can be heat treated, by a processing method, to improve the mechanical strength and thermal stability of the component that are higher than ones typically obtained from components that are additively manufactured from conventional Al—Si-based or Al—Cu-based alloys.

In one embodiment, the aluminum alloy of the present disclosure can be utilized in traditional manufacturing including aluminum casting, rolling, extrusion, forging and additive manufacturing including selective laser melting.

Additionally, the aluminum alloys, in metal powder form, can be processed by powder metallurgy processes such as hot isostatic pressing, powder molding, and extrusion, which do not cause a liquid phase to form during the manufacturing process. When processed by one of the powder metallurgy processes, the aluminum alloys have excellent mechanical properties and thermal stability at operating temperatures exceeding 250° C., and as high as 550° C.

Additionally, the aluminum alloys can be fabricated by other traditional manufacturing methods such as aluminum casting and wrought forming such as rolling, forging, extrusion.

The aluminum alloys can be fabricated as pre-alloyed metal powders to be utilized in additive manufacturing or a powder metallurgy processes. The aluminum alloy powders can be fabricated by gas-atomizing, plasma-atomizing, rotating-electrode processing, or mechanical alloying followed by an optional plasma-spheridizing process, in which the powders have uniform alloy composition. The pre-alloyed metal powders may have a particle size ranging from about 1 to about 500 micrometers. The powders are generally spherical, which is essential for some additive manufacturing processes, or they can be irregularly shaped, which is common for powder metallurgy processes.

The Al—Mn-based alloys can take advantage of the high solidification rates to retain most of the Mn in a solid solution of the aluminum matrix, exceeding the equilibrium solubility. Such high cooling rates can be achieved with certain casting processes, but are easily achieved in many welding, atomizing, and additive manufacturing processes where the cooling rates can greatly exceed about 10³° C./s. Increasing the amount of Mn in solid solution, under certain conditions, can lead to greater solid-solution and precipitation strengthening. During a heat treatment, Mn will typically form Al₆Mn or Al₁₂Mn precipitates. When Zr is added to the Al—Mn system, Al₃Zr nanoprecipitates can also form, further increasing the strength. Additionally, when Fe and Si are added to the Al—Mn system, and the alloy is heat treated, Al—Mn precipitates will form containing Fe and Si. These precipitates are especially useful for high temperature performance.

In one embodiment, the present disclosure provides a method of producing the aluminum alloys by a rapid solidification process, wherein the process is selected from a group consisting of melt spinning, melt extraction, beam glazing, spray deposition, gas atomization, plasma atomization, and plasma spherization. In some embodiments, the aluminum alloys are fabricated into powder by the application of one or more of these methods. In some embodiments, the powders comprise spherical particles, which can be prepared by gas-atomization, plasma-atomization, or plasma spherization.

In one embodiment, the aluminum alloys are thermally stable (e.g., retain their properties) up to 400° C. In one embodiment, the aluminum alloys are thermally stable (e.g., retain their properties) up to 500° C. In one embodiment, the aluminum alloys are thermally stable (e.g., retain their properties) up to 550° C. In another embodiment, the aluminum alloys are creep resistant up to 400° C. In another embodiment, the aluminum alloys are creep resistant up to 500° C.

In one embodiment, the aluminum alloys exhibit a high threshold creep stress, exceeding 90 MPa at 250° C. Material does not creep under a stress that is lower than threshold creep stress.

In one embodiment, the Al-3.6Mn-1.8Fe-1.85i-0.8Zr wt. % aluminum alloy exhibit a high threshold creep stress, exceeding 90 MPa at 250° C. Material does not creep under a stress that is lower than threshold creep stress.

In some embodiments, the aluminum alloys of the present disclosure have a yield strength of from about 200 MPa to about 600 MPa at room temperature and about 180 MPa to about 325 MPa at the testing temperature of 250° C. In some embodiments, the aluminum alloys of the present disclosure have a yield strength of from about 300 MPa to about 600 MPa at room temperature and about 180 MPa to about 325 MPa at the testing temperature of 250° C. In some embodiments, the aluminum alloys of the present disclosure have a yield strength of from about 325 MPa to about 550 MPa at room temperature and about 180 MPa to about 325 MPa at the testing temperature of 250° C. In some embodiments, the aluminum alloys of the present disclosure have a yield strength greater than 200 MPa at room temperature and greater than 160 MPa at the testing temperature of 250° C. In some embodiments, the aluminum alloys of the present disclosure have a yield strength greater than 300 MPa at room temperature and greater than 180 MPa at the testing temperature of 250° C. In one embodiment, the Al-3.6Mn-1.8Fe-1.8Si-0.8Zr wt. % aluminum alloy has yield strength greater than 300 MPa at room temperature and greater than 180 MPa at the testing temperature of 250° C.

In some embodiments, the aluminum alloys of the present disclosure have a yield strength greater than 300 MPa at room temperature, greater than 180 MPa at the testing temperature of 250° C., and greater than 140 MPa at the testing temperature of 300° C. In one embodiment, the Al-3.6Mn-1.8Fe-1.8Si-0.8Zr wt. % aluminum alloy has yield strength greater than 300 MPa at room temperature, greater than 180 MPa at the testing temperature of 250° C., and greater than 140 MPa at the testing temperature of 300° C.

In some embodiments, the aluminum alloys of the present disclosure have a tensile strength greater than 200 MPa. In some embodiments, the aluminum alloys of the present disclosure have a tensile strength greater than 300 MPa. In some embodiments, the aluminum alloys of the present disclosure have a tensile strength of about 200 MPa to about 550 MPa. In some embodiments, the aluminum alloys of the present disclosure have a tensile strength of about 315 MPa to about 550 MPa. In some embodiments, the tensile strength is achieved after aging at a temperature of from 350° C. to 425° C.

In some embodiments, the aluminum alloys of the present disclosure have a maximum (Knoop) hardness value ranging from 50 HK to 200 HK. In some embodiments, the aluminum alloys of the present disclosure have a maximum (Knoop) hardness value ranging from 65 HK to 180 HK. In some embodiments, the maximum hardness is achieved after aging at a temperature of from 350° C. to 425° C.

In some embodiments, the aluminum alloys of the present disclosure have a yield strength of from 300 MPa to 450 MPa, an ultimate tensile strength of from 400 MPa to 525 MPa, and an elongation of from 2% to 15%, when measured at room temperature. In some embodiments, the aluminum alloys of the present disclosure have a yield strength of from 325 MPa to 425 MPa, an ultimate tensile strength of from 425 MPa to 500 MPa, and an elongation of from 4% to 12%, when measured at room temperature. In some embodiments, the aluminum alloys of the present disclosure have a yield strength of from 350 MPa to 400 MPa, an ultimate tensile strength of from 450 MPa to 470 MPa, and an elongation of from 6% to 10%, when measured at room temperature.

In some embodiments, the aluminum alloys of the present disclosure have a yield strength of from 150 MPa to 275 MPa, an ultimate tensile strength of from 100 MPa to 200 MPa, and an elongation of from 2% to 10%, when measured at 250° C. In some embodiments, the aluminum alloys of the present disclosure have a yield strength of from 175 MPa to 250 MPa, an ultimate tensile strength of from 125 MPa to 185 MPa, and an elongation of from 4% to 8%, when measured at 250° C. In some embodiments, the aluminum alloys of the present disclosure have a yield strength of from 200 MPa to 225 MPa, an ultimate tensile strength of from 145 MPa to 160 MPa, and an elongation of from 5% to 7%, when measured at 250° C.

In some embodiments, the aluminum alloys of the present disclosure have a yield strength of from 100 MPa to 225 MPa, an ultimate tensile strength of from 100 MPa to 250 MPa, and an elongation of from 2% to 8%, when measured at 300° C. In some embodiments, the aluminum alloys of the present disclosure have a yield strength of from 125 MPa to 185 MPa, an ultimate tensile strength of from 125 MPa to 185 MPa, and an elongation of from 3% to 6%, when measured at 300° C. In some embodiments, the aluminum alloys of the present disclosure have a yield strength of from 145 MPa to 165 MPa, an ultimate tensile strength of from 150 MPa to 165 MPa, and an elongation of from 4% to 5%, when measured at 300° C.

In some embodiments, a 3-D printed sample of an alloy of the present disclosure has a yield strength of from 300 MPa to 400 MPa, an ultimate tensile strength of from 350 MPa to 550 MPa, and an elongation of from 2% to 20%, when mechanically tested, in tension, at room temperature.

In one embodiment, the aluminum alloys are utilized in automotive, aerospace, motorsports, sport equipment, industrial, chemical, and energy applications, and oil and gas components.

In one embodiment, a fabricated structure from the alloy, in any form (e.g., powder, ribbon, wire, plate, sheet, foil, rod, casting, extrusion, forging etc.), may be used in an application where very high strength and low density is desired, such as in an aerospace component, a satellite component, an automotive component, in a transportation application, in a sporting good or leisure equipment, or in a consumer product.

In one embodiment, a method of the present disclosure includes using pre-alloyed metal powders to fabricate a structure using a method such as additive manufacturing, where such method may include the formation of a liquid phase.

In some embodiments, additive manufacturing, as used herein, refers to a method of forming a net-shape, or near-net-shape component in an additive manner, where material is deposited one layer at a time until the desired three-dimensional shape is achieved. In some embodiments, the additive manufacturing process utilizes spherical metal alloy powders. The spherical metal powders can be made by gas-atomization or plasma-atomization, which naturally produces spherical powders, or by plasma spherization, which transforms irregular particles into spherical powders. In some embodiments, the metal powders utilized in additive manufacturing are fully melted by the energy source and applied to an underlying material, which may be a preexisting substrate or a previously deposited layer of the powder material. The melted powders rapidly solidify (e.g., at cooling rates from about 10³° C./sec and as high as 10⁶° C./sec) and become fused to the underlying material. In some embodiments of the additive manufacturing method, the powders are fused at specific locations by a focused energy source, such as a laser beam or an electron beam, to fabricate a near-net-shape component with high spatial resolution. In some embodiments, the multiple layers of deposited material are re-melted one or more times to achieve complete fusion between each layer of deposited material. In some embodiments, the cooling rates of the melted alloy range from about 10³° C./sec to about 10⁶° C./sec. Without being bound by any particular theory, because of the very high cooling rates inherent to additive manufacturing techniques, such processes are considered far-from-equilibrium, and conventional alloys, which have been optimized for equilibrium processing, cannot be easily processed by such methods.

In one embodiment, a method of the present disclosure includes fabricating a component using a manufacturing technique that utilizes welding where the disclosed alloy is utilized as the base material or as a filler material.

In some embodiments, the method for manufacturing a component from a disclosed aluminum alloy comprises: a) melting recycled or virgin aluminum, while adding any combination of aluminum based-master alloys, such as Al-25 Mn wt. %, Al-20 wt. % Fe, Al-36 wt. % Si, and Al-15 Zr wt. %, and/or pure elements, at a temperature of about 700° C. to about 1000° C. to form a liquid mixture of constituents, wherein the constituents do not comprise any intentionally added scandium; b) casting the melted constituents into a casting mold to form a cast article; c) optionally heat treating the cast article before or after step d at a temperature of about 350° C. to about 550° C. for a time of about 0.25 hours to about 24 hours; and d) fabricating the cast article into a sheet, a foil, a rod, a wire, an extrusion, a forging, or using the cast article in its existing shape.

In some embodiments, the fabricating of step d) comprises hot-forming and/or cold-forming the cast article a sheet, a foil, a rod, a wire, an extrusion, or a forging. In some embodiments, step d) comprises hot-forming the cast article a sheet, a foil, a rod, a wire, an extrusion, or a forging. In some embodiments, step d) comprises cold-forming the cast article a sheet, a foil, a rod, a wire, an extrusion, or a forging.

In some embodiments, the method for manufacturing a component from a disclosed aluminum alloy comprises: a) using the wire or rod of a disclosed aluminum alloy in an additive manufacturing process to manufacture a net-shape or a near-net-shape component; and b) optionally heat aging the net-shape or near-net-shape component at a temperature of about 350° C. to about 550° C. for a time of about 0.25 hour to about 24 hours.

In some embodiments, the method for manufacturing a component from a disclosed aluminum alloy comprises: a) fabricating a ribbon, a chip, or a powder from a disclosed aluminum alloy; b) manufacturing a net-shape component, a near-net-shape component, or an extruded component, using the ribbon, the chip, or the powder in a powder metallurgy process; c) heat treating the net-shape component, the near-net-shape component, or the extruded component at a temperature of about 350° C. to about 550° C. for a time of about 0.25 hours to about 24 hours.

In some embodiments, the method for manufacturing a component from a disclosed aluminum alloy comprises: a) fabricating a powder from a disclosed aluminum alloy; b) using the powder in an additive manufacturing process to manufacture a net-shape or near-net-shape component; c) heat treating the net-shape component, the near-net-shape component at a temperature of about 350° C. to about 550° C. for a time of about 0.25 hours to about 24 hours.

In some embodiments, the method of manufacturing a component from a disclosed aluminum alloy comprises: a) fabricating a powder from the aluminum alloy; b) using the powder in an selective laser melting additive manufacturing process to manufacture a net-shape or near-net-shape component, whereas the powders are welded together by a laser beam at selective locations programed by a computer software; and c) heat treating the net-shape component, the near-net-shape component at a temperature of about 350° C. to about 550° C. for a time of about 0.25 hours to about 24 hours.

In some embodiments, the additive manufacturing process of the present disclosure comprises laser powder bed fusion, directed energy deposition, laser engineered net shaping, and laser cladding. In some embodiments, the aluminum alloys suitable for use in an additive manufacturing process disclosed herein are in the form of powders. In some embodiments, the powders comprise spherical particles. In some embodiments, the spherical particles disclosed herein are prepared by gas-atomization, plasma-atomization, or plasma spherization. In some embodiments, the powders comprise irregularly-shaped particles. The aluminum alloy powders of the present disclosure can be fabricated by any method known in the art, e.g., by gas-atomizing, plasma-atomizing, rotating-electrode processing, or mechanical alloying followed by an optional plasma-spheridizing process, in which the powders have uniform alloy composition. In some embodiments, the aluminum alloys suitable for use in an additive manufacturing process disclosed herein are in the form of wires. In some embodiments, when the aluminum alloy is in the form of a wire, the additive manufacturing process comprises wire-arc additive manufacturing.

In some embodiments, the method to repair, or to form a protective coating on, a component made from an aluminum or a magnesium alloy, the method comprising: using the powder of a disclosed aluminum alloy in a cold spray process, a thermal spray process, a laser-assisted cold spray process, or a laser cladding process to repair, or to form a protective coating on, the component.

Unless expressly stated to the contrary, all ranges cited herein are inclusive. It is to be understood that any range cited herein includes within its scope all of the sub-ranges within that range.

The term “about” and its grammatical equivalents in relation to a reference numerical value and its grammatical equivalents as used herein can include a range of values plus or minus 10% from that value, such as a range of values plus or minus 10%, 9%, 8%, 7%, 6%, 5%, 4%, 3%, 2%, or 1% from that value. For example, the amount “about 10” includes amounts from 9 to 11.

### NUMBERED EMBODIMENTS OF THE DISCLOSURE

Other subject matter contemplated by the present disclosure is set out in the following numbered embodiments.

1. An aluminum alloy comprising:
about 1 to about 10% by weight manganese;
about 0.3 to about 2% by weight zirconium; and
aluminum as the remainder,
wherein the alloy does not comprise any intentionally added scandium.
   2. The aluminum alloy of embodiment 1, further comprising:
about 0 to about 5% by weight silicon; and/or
about 0 to about 5% by weight iron.
   2a. The aluminum alloy of embodiment 1, further comprising:
about 0.3 to about 2% by weight silicon; and/or
about 0.3 to about 2% by weight iron.
   3. The aluminum alloy of any one of embodiments 1 and 2a, further comprising about 0.1 to about 1% by weight of or more of titanium, hafnium, vanadium, niobium, tantalum, chromium, molybdenum, and tungsten.
   3a. The aluminum alloy of any one of embodiments 1-2a, further comprising about 0.25 to about 0.75% by weight of molybdenum.
   4. The aluminum alloy of any one of embodiments 1-3, further comprising about 0.05 to about 0.5% by weight of tin for inoculating alpha-phase precipitation.
   5. The aluminum alloy of any one of embodiments 1-3, further comprising about 0.05 to about 1% by weight of copper for inoculating alpha-phase precipitation.
   6. The aluminum alloy of any one of embodiments 1-5, further comprising about 0.5% or less by weight of unavoidable impurities.
   7. The aluminum alloy of any one of embodiments 1-6, wherein the amount of scandium is less than about 0.5% by weight.
   7a. The aluminum alloy of any one of embodiments 1-6, wherein the amount of scandium is less than about 0.2% by weight.
   8. The aluminum alloy of any one of embodiments 1-7a, comprising about 1 to about 7% by weight manganese.
   8a. The aluminum alloy of any one of embodiments 1-7a, comprising about 2.5 to about 5% by weight manganese.
   9. The aluminum alloy of any one of embodiments 1-8a, comprising about 0.2 to about 1.5% by weight zirconium.
   9a. The aluminum alloy of any one of embodiments 1-8a, comprising about 0.5 to about 1% by weight zirconium.
   10. The aluminum alloy of any one of embodiments 2-9a, comprising about 0.2 to about 2% by weight silicon.
   10a. The aluminum alloy of any one of embodiments 2-9a, comprising about 0.5 to about 1.8% by weight silicon.
   11. The aluminum alloy of any one of embodiments 2-10a, comprising about 0.2 to about 2% by weight iron.
   11a. The aluminum alloy of any one of embodiments 2-10a, comprising about 0.5 to about 1.8% by weight iron.
   12. An aluminum alloy comprising:
about 1 to about 10% by weight manganese;
about 0.3 to about 2% by weight zirconium;
about 0 to 5% by weight iron;
about 0 to 5% by weight silicon; and
aluminum as the remainder,
wherein the alloy does not comprise any intentionally added scandium.
   13. The aluminum alloy of embodiment 12, comprising about 1 to about 7% by weight manganese.
   13a. The aluminum alloy of embodiment 12 or 13, comprising about 2.5 to about 5% by weight manganese.
   14. The aluminum alloy of any one of embodiments 12-13a, comprising about 0.2 to about 1.5% by weight zirconium.
   14a. The aluminum alloy of any one of embodiments 12-13a, comprising about 0.5 to about 1% by weight zirconium.
   15. The aluminum alloy of any one of embodiments 12-14a, comprising about 0.2 to about 2% by weight silicon.
   15a. The aluminum alloy of any one of embodiments 12-14a, comprising about 0.5 to about 1.8% by weight silicon.
   16. The aluminum alloy of any one of embodiments 12-15a, comprising about 0.2 to about 2% by weight iron.
   16a. The aluminum alloy of any one of embodiments 12-15a, comprising about 0.5 to about 1.8% by weight iron.
   17. The aluminum alloy of any one of embodiments 12-16a, further comprising about 0.1 to about 1% by weight of one or more of titanium, hafnium, vanadium, niobium, tantalum, chromium, molybdenum, and tungsten.
   17a. The aluminum alloy of any one of embodiments 12-16a, further comprising about 0.25 to about 0.75% by weight of molybdenum.
   18. The aluminum alloy of any one of embodiments 12-17a, further comprising about 0.05 to about 0.5% by weight of tin for inoculating alpha-phase precipitation.
   19. The aluminum alloy of any one of embodiments 12-17a, further comprising about 0.05 to about 1% by weight of copper for inoculating alpha-phase precipitation.
   20. The aluminum alloy of any one of embodiments 12-19, further comprising about 0.5% or less by weight of unavoidable impurities.
   20a. The aluminum alloy of any one of embodiments 12-19, further comprising about 0.2% or less by weight of unavoidable impurities.
   21. The aluminum alloy of any one of embodiments 12-20a, wherein the amount of scandium is less than about 0.5% by weight.
   21a. The aluminum alloy of any one of embodiments 12-20a, wherein the amount of scandium is less than about 0.2% by weight.
   22. The aluminum alloy of any one of embodiments 1-21a, wherein the alloy comprises an aluminum matrix with a simultaneous dispersion of precipitates bearing Mn, Fe, and/or Si, and Al₃Zr primary precipitates having an average diameter ranging from about 0.05 to about 5 μm,
   23. The aluminum alloy of any one of embodiments 1-23, wherein the alloy comprises Al₃Zr nano-precipitates with L12 crystal structure having an average diameter ranging from about 3 to about 50 nm.
   24. An aluminum alloy comprising:
about 1 to about 5% by weight manganese;
about 0.3 to 2% by weight iron;
about 0.3 to 2% by weight silicon; and
aluminum as the remainder,
wherein the alloy does not comprise any intentionally added scandium.
   24a. The aluminum alloy of embodiment 24, comprising about 1.2 to about 3.6% by weight manganese.
   24b. The aluminum alloy of embodiment 24 or 24a, comprising about 0.6 to 1.8% by weight silicon.
   24c. The aluminum alloy of any one of embodiments 24-24b, comprising about 0.6 to 1.8% by weight iron.
   24d. The aluminum alloy of any one of embodiments 24-24c, further comprising about 0.1 to about 0.5% by weight zirconium.
   24e. The aluminum alloy of any one of embodiments 24-24c, further comprising about 0.3% by weight zirconium.
   24f. The aluminum alloy of any one of embodiments 24-24e, wherein the amount of scandium is less than about 0.5% by weight.
   24g. The aluminum alloy of any one of embodiments 24-24e, wherein the amount of scandium is less than about 0.2% by weight.
   24h. The aluminum alloy of any one of embodiments 24-24g, further comprising about 0.2% or less by weight of unavoidable impurities.
   24i. The aluminum alloy of any one of embodiments 24-24h, further comprising about 0.05 to about 0.5% by weight of tin for inoculating alpha-phase precipitation.
   24j. The aluminum alloy of any one of embodiments 24-24i, further comprising about 0.05 to about 1% by weight of copper for inoculating alpha-phase precipitation.
   24k. The aluminum alloy of any one of embodiments 24-24h, further comprising about 0.05 to about 1% by weight of titanium or chromium.
   25. The aluminum alloy of any one of embodiments 1-24k, wherein the alloy can be utilized in traditional manufacturing and additive manufacturing.
   25a. The aluminum alloy of embodiment 25, wherein the traditional manufacturing includes aluminum casting, rolling, extrusion, or forging, and the additive manufacturing includes laser melting.
   26. A method of producing a metallic structure, the method comprising:
a) melting recycled or virgin aluminum, while adding aluminum-master alloys or pure elements, at a temperature of about 700° C. to about 1000° C. to form a liquid mixture of constituents, the constituents comprising the alloy described of any one of embodiments 1-23, and wherein the constituents do not comprise any intentionally added scandium;
b) casting the melted constituents into a casting mold to form a cast article;
c) optionally heat treating the cast article before or after step d at a temperature of about 350° C. to about 550° C. for a time of about 0.25 hours to about 24 hours to form a cast article comprising a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm; and
d) fabricating the cast article into a sheet, a foil, a rod, a wire, an extrusion, a forging, or using the cast article in its existing shape, wherein the fabricating optionally comprises hot-forming and/or cold-forming the cast article.
   27. A method of manufacturing a component, the method comprising:
using the wire or rod produced by the method of embodiment 26 in an additive manufacturing process to manufacture a net-shape or a near-net-shape component; and
optionally heat aging the net-shape or near-net-shape component at a temperature of about 350° C. to about 550° C. for a time of about 0.25 hour to about 24 hours, to achieve a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm.
   28. A method of manufacturing a component, the method comprising:
fabricating a ribbon, a chip, or a powder from the aluminum alloy of any one of embodiments 1-23;
manufacturing a net-shape component, a near-net-shape component, or an extruded component, using the ribbon, the chip, or the powder in a powder metallurgy process; and
optionally, heat treating the net-shape component, the near-net-shape component, or the extruded component at a temperature of about 350° C. to about 550° C. for a time of about 0.25 hours to about 24 hours to achieve a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm.
   29. A method of manufacturing a component, the method comprising:
fabricating a powder from the aluminum alloy of any one of embodiments 1-23;
using the powder in an additive manufacturing process to manufacture a net-shape or near-net-shape component; and
optionally, heat treating the net-shape component, the near-net-shape component at a temperature of about 350° C. to about 550° C. for a time of about 0.25 hours to about 24 hours to achieve a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm.
   30. A method of manufacturing a component, the method comprising:
fabricating a powder from the aluminum alloy of any one of embodiments 1-23;
using the powder in an selective laser melting additive manufacturing process to manufacture a net-shape or near-net-shape component, whereas the powders are welded together by a laser beam at selective locations programed by a computer software; and
optionally, heat treating the net-shape component, the near-net-shape component at a temperature of about 350° C. to about 550° C. for a time of about 0.25 hours to about 24 hours to achieve a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm.
   31. A method of producing the aluminum alloy of any one of embodiments 1-23 by a rapid solidification process, wherein the process is selected from a group consisting of melt spinning, melt extraction, beam glazing, spray deposition, gas atomization, plasma atomization, and plasma spherization.
   32. A powder fabricated from the aluminum alloy of any one of embodiments 1-23.
   32a. An aluminum alloy prepared according to the method of any one of embodiments 26-31.
   33. An aluminum alloy manufactured by the method of embodiment 29, having a yield strength greater than 300 MPa at room temperature and greater than 180 MPa at the testing temperature of 250° C.
   34. An aluminum alloy manufactured by the method of embodiment 29, having a yield strength greater than 200 MPa at room temperature and greater than 100 MPa at the testing temperature of 250° C.
   35. An aluminum alloy manufactured by the method of embodiment 29, having a yield strength greater than 300 MPa at room temperature, greater than 180 MPa at the testing temperature of 250° C., and greater than 140 MPa at the testing temperature of 300° C.
   36. An aluminum alloy manufactured by the method of embodiment 29, having a yield strength greater than 200 MPa at room temperature, greater than 100 MPa at the testing temperature of 250° C., and greater than 50 MPa at the testing temperature of 300° C.
   37. An aluminum alloy of any one of embodiments 1-23 that is thermally stable up to 400° C.
   38. An aluminum alloy of any one of embodiments 1-23 that are creep resistant up to 400° C. and has a threshold creep stress higher than 90 MPa at 250° C. 39. The aluminum alloy of any one of embodiments 1-23 that can be utilized in applications that have operating temperatures above 200° C.
   40. The aluminum alloy of any one of embodiments 1-23 that can be utilized in applications such as automotive, aerospace and sport equipment components.

### EXAMPLES

### Test Methods

The following test methods were used to evaluate the properties of the disclosed aluminum alloys:

Tensile testing (e.g., yield strength (YS), ultimate tensile strength (UTS), elongation (El)) was evaluated at room temperature according to ASTM E8—Standard Test Methods for Tension Testing of Metallic Materials.

Tensile testing (e.g., yield strength (YS), ultimate tensile strength (UTS), elongation (El)) was evaluated at elevated temperature according to ASTM E21—Standard Test Methods for Elevated Temperature Tension Tests of Metallic Materials.

Vickers and Knoop Hardness were evaluated according to ASTM E92-Standard Test Methods for Vickers Hardness and Knoop Hardness of Metallic Materials.

Compressive yield strength (Table 3) was evaluated according to ASTM E209-Standard Practice for Compression Tests of Metallic Materials at Elevated Temperatures with Conventional or Rapid Heating Rates and Strain Rates.

Electrical conductivity testing was evaluated according to ASTM E1004—Standard Test Method for Determining Electrical Conductivity Using the Electromagnetic (Eddy Current) Method.

Surface roughness measurement was evaluated according to ISO 4287—Surface texture: Profile method—Terms, definitions and surface texture parameters.

Tensile creep testing (e.g., steady-state creep strain rate) was evaluated at elevated temperature according to ASTM E139—Standard Test Methods for Conducting Creep, Creep-Rupture, and Stress-Rupture Tests of Metallic Materials.

### Example 1

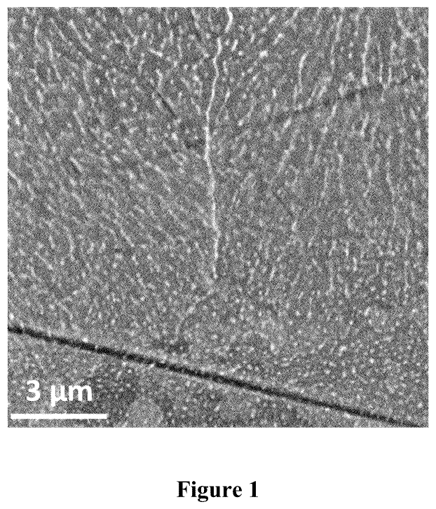

Multiple Al—Mn—Fe—Si-based aluminum alloys are fabricated by melt-spinning, in which the alloys are melted in an inert environment then poured on a cold, spinning copper-wheel. The high-speed, spinning wheel rapidly solidifies the molten aluminum into small pieces of metallic ribbons. The aluminum alloys comprise Mn in concentration ranging from 1.2 wt. % to 6 wt. %, Fe in a concentration ranging from 0 wt. % to 1.8 wt. %, Si in a concentration ranging from 0 wt. % to 1.8 wt. %, Zr in a concentration ranging from 0 wt. % to 1 wt. %. The aluminum alloys also comprise other transition elements such as Mo. Table 1 shows the Knoop hardness of the as-fabricated melt-spun samples, which have value ranges from about 50 HK to 140 HK (or an estimated tensile strength from 150 MPa to 420 MPa). All fabricated alloys are isochronally aged (25° C./1h) from 25° C. to 500° C. Nearly all alloys achieved higher hardness values after aging. Alloys that contain Zr achieve maximum hardness in the temperature ranges from 350° C. to 425° C. Maximum hardness value ranges from 68 HK to 171 HK (or an estimated tensile strength from 203 MPa to 513 MPa). These results show that all of the studied alloys have an extreme thermal stability up to 500° C. (i.e. strength is not decreased under high temperature exposure). A few studied alloys can achieve high tensile strength (>300 MPa) and thermal stability up to 500° C. An example microstructure is displayed in FIG. 1, showing a scanning electron micrograph of a melt-spun ribbon of Al-2.4Mn-1.2Fe-1.2Si-1.0Zr wt. %. The structure displays fine primary Al—Mn—Fe—Si alpha-phase precipitates homogenously dispersed throughout the sample. Based on the isochronal aging behavior, we expect the sample contains a high number density of L1₂-structured Al₃Zr nanoprecipitates after aging.

TABLE 1
List of Al—Mn—Fe—Si-based aluminum alloys including alloy composition, Knoop hardness
of melt-spun ribbon, maximum value of Knoop hardness after isochronal aging treatment,
aging temperature to achieve maximum Knoop hardness, and estimated maximum tensile strength.

| | Melt-Spun | Maximum | Aging | Estimated maximum |
|---|---|---|---|---|
| Composition | Hardness | Hardness | temperature | tensile strength |
| (wt. %) | (HK) | (HK) | (° C.) | (MPa)¹ |
| Al—1.2Mn—0.6Fe—0.6Si | 56.1 ± 6.9 | 67.6 ± 6.7 | 375 | 203 |
| Al—1.8Mn—0.9Fe—0.9Si | 72.1 ± 10.1 | 114.0 ± 7.0 | 375 | 342 |
| Al—2.4Mn—1.2Fe—1.2Si | 84.1 ± 8.7 | 92.3 ± 2.8 | 425 | 277 |
| Al—3.6Mn—1.8Fe—1.8Si | 116.8 ± 6.3 | 116.8 ± 6.3 | 25 | 350 |
| Al—1.8Mn—0.9Fe—0.9Si—0.5Zr | 72.4 ± 9.5 | 111.2 ± 5.5 | 400 | 334 |
| Al—1.8Mn—0.9Fe—0.9Si—1.0Zr | 86.3 ± 5.6 | 130.8 ± 2.4 | 400 | 392 |
| Al—1.8Mn—0.9Fe—0.9Si—0.5Mo | 77.4 ± 2.7 | 78.4 ± 5.7 | 400 | 235 |
| Al—1.8Mn—0.9Fe—0.9Si—0.5Zr—0.5Mo | 71.8 ± 10.8 | 117.3 ± 4.3 | 425 | 352 |
| Al—1.8Mn—0.9Fe—0.9Si—1.0Zr—0.5Mo | 82.1 ± 5.9 | 122.7 ± 6.8 | 425 | 368 |
| Al—2.4Mn—1.2Fe—1.2Si—1.0Zr | 111.5 ± 7.4 | 171.1 ± 11.2 | 400 | 513 |
| Al—5.0Mn—1.0Zr | 105.5 ± 5.7 | 146.9 ± 7.9 | 400 | 441 |
| Al—5.0Mn—0.5Fe—0.5Si—1.0Zr | 109.4 ± 4.2 | 151.6 ± 7.0 | 375 | 455 |
| Al—5.0Mn—1.0Fe—1.0Si—1.0Zr | 140.0 ± 16.2 | 147.2 ± 12.2 | 350 | 442 |
| Al—6.0Mn—0.5Fe—0.5Si—1.0Zr | 122.3 ± 4.5 | 150.7 ± 9.2 | 400 | 452 |

¹Estimated maximum tensile strength is derived from maximum hardness values by conversion following HK * 3 = estimated maximum tensile strength

While mechanical property data for alloys fabricated by a melt-spinning method is provided, it can be understood for a person skilled in the art that these properties can also be achieved in alloys fabricated by traditional manufacturing methods, such as aluminum casting and by additive manufacturing. In particular, the sample properties can be achieved in alloys fabricated into aluminum powders such as melt extraction, beam glazing, spray deposition, gas atomization, plasma atomization, and plasma spherization and final components that produced by powder metallurgy processes such as hot isostatic pressing, powder molding, and extrusion.

### Example 2

An aluminum alloy of the present disclosure (A1-3.6Mn-1.8Fe-1.8Si-0.8Zr wt. %) was fabricated into spherical aluminum powders by gas atomization. Final components were then additively manufactured (i.e. 3D-printing), using selective laser melting, utilizing these aluminum alloy powders. The final components achieve density >99.5% of theorical density of the alloys, which is important to achieve good mechanical properties in additive manufacturing.

Isothermal aging treatments, in the temperature range from 250° C. to 400° C. up to 100 hours, were carried out to examine thermal stability of the 3D-printed samples from an aluminum alloy. Samples were built on an unheated build plate. Table 2 shows that hardness of a 3D-printed sample is stable and relatively unchanged up to 350° C. This suggests that the alloy can be operated under constant heat exposure up to 350° C. for a long period of time.

TABLE 2
Vickers hardness (HV) of an alloy, fabricated by additive manufacturing
(selective laser melting) on an unheated build plate, measured
as-printed and after aging at temperatures for 100 hours.

| | Vickers Hardness (HV) | | | | |
|---|---|---|---|---|---|
| 3D-printed Aluminum Alloys (wt. %) | 25° C. | 250° C. | 300° C. | 350° C. | 400° C. |
| Al—3.6Mn—1.8Fe—1.8Si—0.8Zr (disclosed alloy) | 125 | 125 | 135 | 122 | 98 |

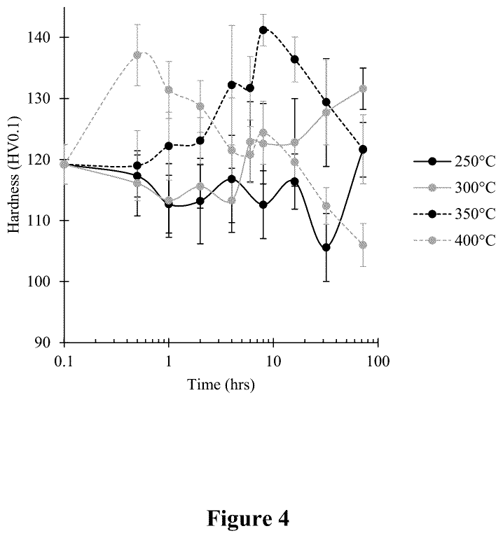

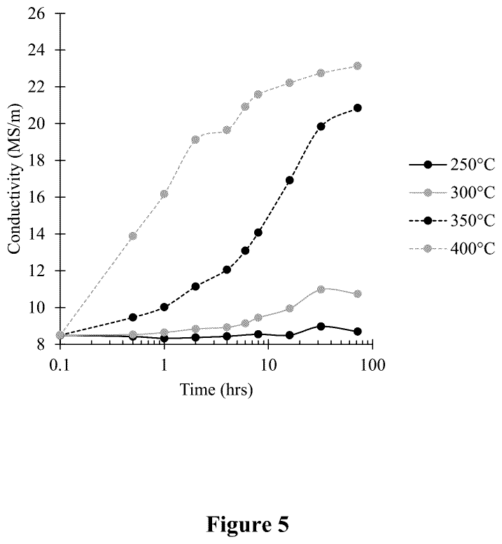

FIGS. 4 and 5 show isothermal Vickers microhardness and electrical conductivity curves, respectively, of samples produced on a heated build plate, which were studied for precipitation hardening response due to aging and for thermal stability. There is limited change in hardness or conductivity at 250° C. up to 72 hours, demonstrating the thermal stability of the alloy at that temperature. Aging at 300° C. exhibits a gradual aging response due to precipitation which apparently has not progressed to coarsening by 72 hours. Aging at 350° C. displays a peak in hardness around at 10 hours, after which coarsening occurs and hardness decreases to as-built levels after 72 hours. Aging at 400° C. shows a rapid increase in hardness at 0.5 hours followed by coarsening that results in a decrease in hardness.

### Example 3

Mechanical strength at temperature is an important property for high-temperature aluminum alloys. An alloy of the present disclosure (A1-3.6Mn-1.8Fe-1.8Si-0.8Zr wt. %) was fabricated into a spherical aluminum powder by gas atomization. Fully dense components (>99% of theoretical density) were then additively manufactured (i.e. 3D-printing), using selective laser melting, utilizing these aluminum alloy powders. The 3D-printed sample of the alloy was mechanically tested, in compression, at temperatures of 200° C., 250° C. and 300° C. The results are listed in Table 3. The alloy Al-3.6Mn-1.8Fe-1.8Si-0.8Zr wt. % achieves a compressive yield strength from 372 MPa to 418 MPa at room temperature, depending on aging treatment. This alloy achieves a compressive yield strength from 244 MPa to 295 MPa at 200° C., 203 MPa to 248 MPa at 250° C., and 160 MPa to 197 MPa at 300° C. The achieved values are dependent on aging temperatures. For comparison, several referenced 3D-printed aluminum alloys, including commercially available AlSi 10Mg and Scalmalloy (Al—Mg—Sc-based) are shown in Table 3. It shows that mechanical strength of the alloys at certain aging treatments outperform the referenced alloys at all testing temperatures.

TABLE 3
Compressive yield strength at room and elevated temperatures of disclosed alloys, compared with
reference alloys. All alloys are fabricated by additive manufacturing (selective laser melting).

| | | Yield strength at temperature (MPa) | | | |
|---|---|---|---|---|---|
| | | (10⁻³ s⁻¹ strain rate) | | | |
| | 3D-printed Aluminum Alloys | 25° C. | 200° C. | 250° C. | 300° C. |
| Disclosed alloy | Al—3.6Mn—1.8Fe—1.8Si—0.8Zr (as—processed) | 372 | 285 | 248 | 197 |
| Disclosed alloy | Al—3.6Mn—1.8Fe—1.8Si—0.8Zr (100 h exposure at 250° C.) | 385 | 295 | 246 | — |
| Disclosed alloy | Al—3.6Mn—1.8Fe—1.8Si—0.8Zr (100 h exposure at 300° C.) | 405 | 265 | 229 | 173 |
| Disclosed alloy | Al—3.6Mn—1.8Fe—1.8Si—0.8Zr (3 h exposure at 375° C.) | 418 | 244 | 203 | 160 |
| Reference alloy** | AlSi10Mg | 200 | 160 | 140 | 70 |
| Reference alloy** | A20X T6 | 445 | 311 | 215 | — |
| Reference alloy** | Al—10Ce—10Mn | 268* | 295* | 200 | 160 |
| Reference alloy** | Scalmalloy (Al—Mg—Sc) | 450 | 140 | 75 | — |

*no yield at this temperature due to no ductility,
**referenced alloy is typically tested at 10⁻⁴ s⁻¹ strain rate

The 3D-printed samples of disclosed alloys were mechanically tested, in tension, at temperatures of 200° C., 250° C. and 300° C. The results are listed in Table 4. The disclosed alloy Al-3.6Mn-1.8Fe-1.8Si-0.8Zr wt. % achieves a tensile yield strength from 357 MPa to 398 MPa at room temperature, depending on aging treatment. This alloy achieves a tensile yield strength from 244 MPa to 250 MPa at 200° C., 204 MPa to 213 MPa at 250° C., and 154 MPa to 191 MPa at 300° C. The achieved values are dependent of aging temperatures. For comparison, several referenced 3D-printed aluminum alloys including commercially available AlSi10Mg and Scalmalloy (Al—Mg—Sc-based) are shown in Table 4. It shows that mechanical strength of the disclosed alloys at certain aging treatments are comparable or outperform the referenced alloys, especially at temperatures equal or above 250° C.

TABLE 4
Tensile yield strength at room and elevated temperatures of disclosed alloys, compared with reference
alloys. All alloys are fabricated by additive manufacturing (selective laser melting).

| | | Yield strength at temperature (MPa) | | | |
|---|---|---|---|---|---|
| | | (10⁻⁴ s⁻¹ strain rate) | | | |
| | 3D-printed Aluminum Alloys | 25° C. | 200° C. | 250° C. | 300° C. |
| Disclosed alloy | Al—3.6Mn—1.8Fe—1.8Si—0.8Zr (as-processed) | 357 | 244 | 213 | 191 |
| Disclosed alloy | Al—3.6Mn—1.8Fe—1.8Si—0.8Zr (8 h exposure at 350° C.) | 398 | 250 | 204 | 154 |
| Reference alloy** | AlSi10Mg | 200 | 160 | 140 | 70 |
| Reference alloy** | A20X T6 | 445 | 311 | 215 | — |
| Reference alloy** | Al—10Ce—10Mn | 268* | 295* | 200 | 160 |
| Reference alloy** | Scalmalloy (Al—Mg—Sc) | 450 | 140 | 75 | — |

*no yield at this temperature due to no ductility,
**referenced alloy is typically tested at 10⁻⁴ s⁻¹ strain rate

TABLE 5
Tensile mechanical property of disclosed alloys at room and elevated temperatures.

| | | Room temperature | | | At 250° C. | | | At 300° C. | | |
|---|---|---|---|---|---|---|---|---|---|---|
| | | YS | UTS | El | YS | UTS | El | YS | UTS | El |
| | | (MPa) | (MPa) | (%) | (MPa) | (MPa) | (%) | (MPa) | (MPa) | (%) |
| Disclosed | Al-3.6Mn-1.8Fe-1.8Si-0.8Zr | 357 | 464 | 10 | | | | | | |
| alloy | (as-processed) | | | | | | | | | |
| Disclosed | Al-3.6Mn-1.8Fe-1.8Si-0.8Zr | 398 | 456 | 6 | 201 | 203 | 6 | 149 | 154 | 4.3 |
| alloy | (8 h exposure at 350° C.) | | | | | | | | | |
| Disclosed | Al-3.6Mn-1.8Fe-1.8Si-0.8Zr | | | | 223 | 248 | 6 | | | |
| alloy | (100 h exposure at 250° C.) | | | | | | | | | |
| Disclosed | A1-3.6Mn-1.8Fe-1.8Si-0.8Zr | | | | | | | 158 | 161 | 4 |
| alloy | (100 h exposure at 300° C.) | | | | | | | | | |

The 3D-printed samples of disclosed alloys are mechanically tested, in tension, at room temperature, 250° C. and 300° C. The results are listed in Table 5. The disclosed alloy Al-3.6Mn-1.8Fe-1.8Si-0.8Zr wt. % achieves a yield strength from 357 MPa to 398 MPa, ultimate tensile strength from 456 MPa to 464 MPa, and elongation from 6% to 10% at room temperature, depending on aging treatment. The disclosed alloy Al-3.6Mn-1.8Fe-1.8Si-0.8Zr wt. % achieves a yield strength from 201 MPa to 223 MPa, ultimate tensile strength from 203 MPa to 248 MPa, and elongation of 6% at 250° C., depending on aging treatment. The disclosed alloy Al-3.6Mn-1.8Fe-1.8Si-0.8Zr wt. % achieves a yield strength from 149 MPa to 158 MPa, ultimate tensile strength from 154 MPa to 161 MPa, and elongation of 4% to 4.3% at 300° C., depending on aging treatment.

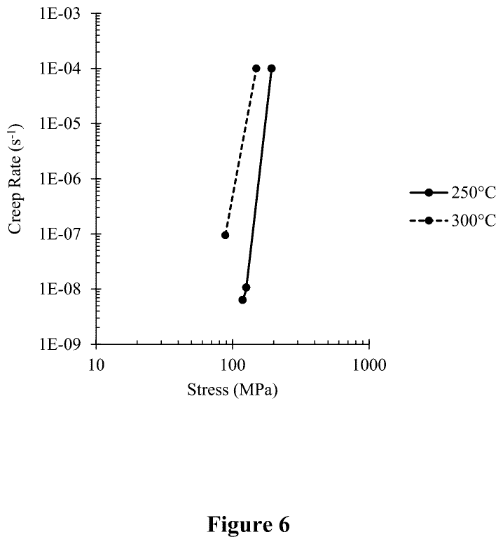

FIG. 6 shows the steady-state (i.e., secondary), creep rate of disclosed alloys at testing temperatures of 250° C. and 300° C. respectively. The disclosed alloy Al-3.6Mn-1.8Fe-1.8Si-0.8Zr wt. % achieves a creep rate of 6.4E-09 s 1 at a stress of 118 MPa, 1.1E-08 s 1 at a stress of 128 MPa, 1E-4 s′ at a stress of 193 MPa at a temperature of 250° C. The disclosed alloy Al-3.6Mn-1.8Fe-1.8Si-0.8Zr wt. % achieves a creep rate of 9.5E-08 s 1 at 89 MPa and 1E-4 s 1 at 149 MPa at a temperature of 300° C.

TABLE 6
Tensile mechanical properties of disclosed alloys at room
temperature in a variety of build orientations, conditions, and
fabrication states.

| | | Machined | | | Net-Shape | | |
|---|---|---|---|---|---|---|---|
| Build | | YS | UTS | E1 | YS | UTS | El |
| Orientation | Condition | (MPa) | (MPa) | (%) | (MPa) | (MPa) | (%) |
| Horizontal | As-Printed | 396 | 517 | 18 | | | |
| Horizontal | 400° C./16 hr | 331 | 379 | 11 | | | |
| Vertical | As-Printed | 314 | 470 | 11 | 308 | 407 | 5 |
| Vertical | 400° C./16 hr | 340 | 396 | 5 | 322 | 363 | 2 |

The 3D-printed samples of disclosed alloys are mechanically tested, in tension, at room temperature as sample fabricated as net-shape specimens or by machining from preforms, in various build orientations and heat treatment conditions. The results are listed in Table 6. The disclosed alloy Al-3.6Mn-1.8Fe-1.8Si-0.8Zr wt. % achieves yield strengths from 308 to 396 MPa, ultimate tensile strength from 363 to 517 MPa, and elongation of 2 to 18% depending on build orientation, condition, and fabrication state.

TABLE 7
Tensile mechanical properties of net-shape specimens and electrical conductivity
properties of disclosed alloy Al-3.6Mn-1.8Fe-1.8Si-0.8Zr wt. % at room temperature in a
variety of heat treatment conditions.

| | 350° C. | | | | 400° C. | | | | 450° C. | | | | 500° C. | | | |
|---|---|---|---|---|---|---|---|---|---|---|---|---|---|---|---|---|
| Time | YS | (MPa) | El | EC | YS | UTS | E1 | EC | YS | UTS | El | EC | YS | UTS | El | EC |
| (hr) | (MPa) | UTS | (%) | (MS/m) | (MPa) | (MPa) | (%) | (MS/m) | (MPa) | (MPa) | (%) | (MS/m) | (MPa) | (MPa) | (%) | (MS/m) |
| As- | 308 | 406 | 4.5 | 6.9 | 308 | 406 | 4.5 | 6.9 | 308 | 406 | 4.5 | 6.9 | 308 | 406 | 4.5 | 6.9 |
| Built | | | | | | | | | | | | | | | | |
| 0.25 | | | | | | | | | | | | | 262 | 321 | 3 | 21.2 |
| 0.5 | | | | | 342 | 351 | 1.5 | — | | | | | 230 | 297 | 3.9 | 22.1 |
| 2 | 328 | 386 | 2.3 | 12.5 | 354 | 380 | 2.1 | 19.5 | 284 | 330 | 2.7 | 21.3 | 205 | 270 | 6.8 | 22.3 |
| 4 | | | | | | | | | 249 | 285 | 1.2 | 22.5 | | | | |
| 16 | 361 | 392 | 1.2 | 18.9 | 322 | 363 | 1.8 | 21.6 | 213 | 277 | 3.8 | 23 | | | | |

The 3D-printed samples of disclosed alloys are mechanically tested, in tension, at room temperature, and their electrical conductivities measured, after being heat treated at a variety of temperatures and times. Samples are produced in the vertical build orientation, in the shape of tensile specimens, and are not machined further before tensile testing. The results are listed in Table 7. The disclosed alloy Al-3.6Mn-1.8Fe-1.85i-0.8Zr wt. % achieves a yield strength from 205 to 361 MPa, an ultimate tensile strength from 270 to 406 MPa, elongation from 1.2 to 6.8%, and electrical conductivity from 6.9 to 23 MS/m, depending on aging treatment.

The surfaces of 3D-printed samples of disclosed alloys are measured with a profilometer to determine their RA roughness values. The disclosed alloy Al-3.6Mn-1.8Fe-1.85i-0.8Zr wt. % achieves RA roughness values from 191 μin to 730 μin, depending on the specific printing parameters employed in their production.

The microstructure of 3D-printed samples of the disclosed alloy consists of two distinct regions. The zone along melt pool boundaries consists of micron-sized cellular eutectic structures made up of alpha-phase Al—Mn—Fe—Si and aluminum. The interiors of melt pools consist of columnar aluminum crystal grains containing rounded alpha-phase Al—Mn—Fe—Si eutectics.

### Example 4

TABLE 8
List of disclosed Al—Mn—Fe—Si-based aluminum alloys including alloy composition, Vickers
hardness of casting alloys, maximum value of Vickers hardness after isochronal aging treatment,
aging temperature to achieve maximum Vickers hardness, and estimated maximum tensile strength.

| | Vickers | Maximum | Aging | Estimated maximum |
|---|---|---|---|---|
| | Hardness | Hardness | temperature | tensile strength |
| Composition (wt. %) | (HV) | (HV) | (° C.) | (MPa) |
| Al—1.2Mn—0.6Fe—0.6Si | 48.5 ± 1 | 55.5 ± 2 | 400 | 185 |
| Al—1.8Mn—0.9Fe—0.9Si | 57.0 ± 2 | 57.5 ± 2 | 400 | 192 |
| Al—2.4Mn—1.2Fe—1.2Si | 63.4 ± 2 | 63.4 ± 2 | 25 | 211 |
| Al—3.0Mn—1.5Fe—1.5Si | 66.1 ± 3 | 66.1 ± 3 | 25 | 220 |
| Al—3.6Mn—1.8Fe—1.8Si | 70.1 ± 5 | 70.1 ± 5 | 25 | 234 |
| Al—1.8Mn—0.9Fe—0.9Si—0.1Sn | 58.1 ± 3 | 77.1 ± 4 | 400 | 257 |
| Al—1.8Mn—0.9Fe—0.9Si—0.1Sn—0.3Zr | 63.0 ± 2 | 83.7 ± 3 | 425 | 279 |
| Al—1.8Mn—0.9Fe—0.9Si—0.5Ti | 58.6 ± 2 | 63.6 ± 2 | 400 | 212 |
| Al—1.8Mn—0.9Fe—0.9Si—0.5Cr | 55.6 ± 3 | 59.0 ± 2 | 400 | 197 |
| Al—1.8Mn—0.9Fe—0.9Si—0.5Cu | 61.6 ± 6 | 67.2 ± 3 | 425 | 224 |

Multiple disclosed Al—Mn—Fe—Si-based aluminum alloys are fabricated by traditional aluminum casting method, in which the alloys are melted in air then poured on a graphite crucible. The disclosed aluminum alloys comprise Mn in a concentration ranges from 1.2 wt. % to 3.6 wt. %, Fe in a concentration ranges from 0.6 wt. % to 1.8 wt. %, Si in a concentration ranges from 0.6 wt. % to 1.8 wt. %, Zr in a concentration ranges from 0 wt. % to 0.3 wt. %. The disclosed aluminum alloys also comprise other metallic elements such as Ti, Cr and Cu and metalloid element such as Sn. Table 8 shows the Vickers hardness of the as-cast samples, which have value ranges from about 49 HV to 70 HV (or an estimated tensile strength from 163 MPa to 233 MPa). All fabricated alloys are isochronally aged (25° C./1h) from 25° C. to 500° C. All alloys, with Mn content below 2.4 wt. %, achieved higher hardness values after aging, achieving maximum hardness in the temperature ranges from 400° C. to 425° C. Maximum hardness value ranges from 56 HV to 84 HV (or an estimated tensile strength from 185 MPa to 280 MPa). These results show that all studied alloys, with Mn content below 2.4 wt. %, have an extreme thermal stability up to 500° C. (i.e. strength is not decreased under high temperature exposure).

The alloy Al-1.8Mn-0.9Fe-0.95i wt. % with addition of Sn or Cu display a hardness increase during aging at around 400° C., suggesting that Sn or Cu might act as an inoculant of precipitation of alpha-phase Al—Mn—Fe—Si, resulting in a high number density of nanoscale alpha-phase Al—Mn—Fe—Si precipitates in the aluminum matrix.

The alloy Al-1.8Mn-0.9Fe-0.95i wt. % with addition of Sn and Zr display a hardness increase during aging at around 400° C. to 450° C., suggesting that Sn might act as an inoculant of precipitation of alpha-phase Al—Mn—Fe—Si, resulting in a high number density of nanoscale alpha-phase Al—Mn—Fe—Si precipitates in the aluminum matrix. It also suggests that Sn might act as an inoculant of precipitation of L12-structured Al₃Zr, resulting in a high number density of nanoscale L12-structured Al₃Zr precipitates in the aluminum matrix. This behavior is described in U.S. Patent Publication No. 2019/0390312, which is incorporated herein by reference in its entirety.

From the foregoing, it will be understood that numerous modifications and variations can be effectuated without departing from the true spirit and scope of the novel concepts of the present disclosure. It is to be understood that no limitation with respect to the specific embodiments illustrated and described is intended or should be inferred.

1. An aluminum alloy comprising:
about 1 to about 10% by weight manganese;
about 0.3 to about 2% by weight zirconium;
about 0 to about 5% by weight iron;
about 0 to about 5% by weight silicon; and
aluminum as the remainder,
wherein the alloy does not comprise any intentionally added scandium.

2. (canceled)

3. The aluminum alloy of claim 1, further comprising about 0.1 to about 1% by weight of or more of titanium, hafnium, vanadium, niobium, tantalum, chromium, molybdenum, and tungsten.

4. The aluminum alloy of claim 1, further comprising about 0.5% or less by weight of tin for inoculating alpha-phase precipitation.

5. The aluminum alloy of claim 1, further comprising about 1% or less by weight of copper for inoculating alpha-phase precipitation.

6. The aluminum alloy of claim 1, further comprising about 0.5% or less by weight of unavoidable impurities.

7. The aluminum alloy of claim 1, wherein the amount of scandium is less than about 0.5% by weight.

8. The aluminum alloy of claim 1, comprising about 1 to about 7% by weight manganese.

9. The aluminum alloy of claim 8, comprising about 0.2 to about 1.5% by weight zirconium.

10. The aluminum alloy of claim 9, comprising about 0.2 to about 2% by weight silicon.

11. The aluminum alloy of claim 9, comprising about 0.2 to about 2% by weight iron.

12.-21. (canceled)

22. The aluminum alloy of claim 1, wherein, when Fe and/or Si are present, the alloy comprises an aluminum matrix with a simultaneous dispersion of precipitates bearing Mn, Fe, and/or Si, and Al₃Zr primary precipitates having an average diameter ranging from about 0.05 to about 5 μm,

23. The aluminum alloy of claim 22, wherein the alloy comprises Al₃Zr nano-precipitates with L1₂ crystal structure having an average diameter ranging from about 3 to about 50 nm.

24.-25. (canceled)

26. A method of producing a metallic structure, the method comprising:
a) melting recycled or virgin aluminum, while adding aluminum-master alloys or pure elements, at a temperature of about 700° C. to about 1000° C. to form a liquid mixture of constituents, the constituents comprising the alloy of claim 1, wherein the constituents do not comprise any intentionally added scandium;
b) casting the melted constituents into a casting mold to form a cast article;
c) optionally heat treating the cast article before or after step d at a temperature of about 350° C. to about 550° C. for a time of about 0.25 hours to about 24 hours to form a cast article comprising a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm; and
d) fabricating the cast article into a sheet, a foil, a rod, a wire, an extrusion, a forging, or using the cast article in its existing shape, wherein the fabricating optionally comprises hot-forming and/or cold-forming the cast article.

27.-28. (canceled)

29. A method of manufacturing a component, the method comprising:
(a) fabricating a powder from the aluminum alloy of claim 1;
(b) using the powder in an additive manufacturing process to manufacture a net-shape or near-net-shape component; and
(c) optionally, heat treating the net-shape component, the near-net-shape component at a temperature of about 350° C. to about 550° C. for a time of about 0.25 hours to about 24 hours to achieve a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm.

30. A method of manufacturing a component, the method comprising:
(a) fabricating a powder from the aluminum alloy of claim 1;
(b) using the powder in a selective laser melting additive manufacturing process to manufacture a net-shape or near-net-shape component, wherein the powders are welded together by a laser beam at selective locations programed by a computer software; and
(c) optionally, heat treating the net-shape component, the near-net-shape component at a temperature of about 350° C. to about 550° C. for a time of about 0.25 hours to about 24 hours to achieve a simultaneous dispersion of precipitates bearing Mn, Fe and/or Si, Al₃Zr primary precipitates having an average diameter ranging from about 0.05 to about 5 μm, and Al₃Zr nano-precipitates with L12 crystal structure having an average diameter ranging from about 3 to about 50 nm.

31. The method of claim 29, wherein the powder of step (a) is produced by a rapid solidification process, wherein the process is selected from a group consisting of melt spinning, melt extraction, beam glazing, spray deposition, gas atomization, plasma atomization, and plasma spherization.

32. (canceled)

33. An aluminum alloy component manufactured by the method of claim 29, having a yield strength greater than 300 MPa at room temperature and a yield strength greater than 180 MPa at the testing temperature of 250° C.

34. (canceled)

35. An aluminum alloy component manufactured by the method of claim 29, having a yield strength greater than 300 MPa at room temperature, a yield strength greater than 180 MPa at the testing temperature of 250° C., and a yield strength greater than 140 MPa at the testing temperature of 300° C.

36. (canceled)

37. The aluminum alloy of claim 1, wherein the alloy is thermally stable up to 400° C.

38. The aluminum alloy of claim 1, wherein the alloy is creep resistant up to 400° C. and has a threshold creep stress higher than 90 MPa at 250° C.

39.-40. (canceled)

41. The aluminum alloy of claim 1, having a composition selected from the group consisting of: (a) Al-2.4Mn-1.2Fe-1.2Si-1.0Zr; (b); Al-3.6Mn-1.8Fe-1.8Si-0.8Zr; (c) Al-1.8Mn-0.9Fe-0.9Si-0.5Zr; (d) Al-1.8Mn-0.9Fe-0.9Si-1.0Zr; (e) Al-2.4Mn-1.2Fe-1.2Si-1.0Zr; (0 Al-5.0Mn-1.0Zr; (g) Al-5.0Mn-0.5Fe-0.5Si-1.0Zr; (h) Al-5.0Mn-1.0Fe-1.0Si-1.0Zr; (i) Al-6.0Mn-0.5Fe-0.5Si-1.0Zr; (j) Al-1.8Mn-0.9Fe-0.9Si-0.5Zr-0.5Mo; (k) Al-1.8Mn-0.9Fe-0.9Si-1.0Zr-0.5Mo; and (1) Al-1.8Mn-0.9Fe-0.9Si-0.1Sn-0.3Zr.
